(19) United States
(12) Patent Application Publication
(10) Pub. No.: US 2008/0148853 A1
(43) Pub. Date: Jun. 26, 2008

(54) Gas tank having usage monitoring system

(76) Inventor: Hyeung-Yun Kim, Palo Alto, CA (US)

Correspondence Address: Patent Office of Dr. Chung S. Park, P.O. Box 62312, Sunnyvale, CA, 94088-2312, US

(21) Appl. No.: 12/072,256

(22) Filed: Feb. 25, 2008

Related U.S. Application Data
(63) Continuation-in-part of application No. 11/880,043, filed on Jul. 18, 2007.
Application No. 11/880,043 is a continuation-in-part of application No. 11/502,127, filed on Aug. 9, 2006, now Pat. No. 7,325,456.
Application No. 11/502,127 is a continuation-in-part of application No. 10/942,366, filed on Sep. 16, 2004, now Pat. No. 7,117,742.
(60) Provisional application No. 60/505,120, filed on Sep. 22, 2003.
(60) Provisional application No. 60/903,385, filed on Feb. 26, 2007.

(51) Int. Cl. G01N 29/00

(52) U.S. Cl. 73/587

(57) ABSTRACT

A tank having a system for monitoring the structural conditions of the tank. The tank includes: an inner liner adapted to contain a gas thereinside and to prevent permeation of the gas therethrough; a shell surrounding the inner liner; and a plurality of diagnostic network patches (DNP) attached to the outside surface of the shell. Each DNP is able to operate as a transmitter patch or a sensor patch, where the transmitter patch is able to transmit a diagnostic signal and the sensor patch is able to receive the diagnostic signal. The diagnostic signal received by the DNP is analyzed to monitor the structural conditions of the tank.

### CROSS REFERENCE TO RELATED APPLICATIONS

This application is a continuation-in-part of U.S. patent application Ser. No. 11/880,043, filed on Jul. 18, 2007, which is a continuation-in-part of U.S. application Ser. No. 11/502,127, filed on Aug. 9, 2006, now U.S. Pat. No. 7,325,456, which is a continuation-in-part of U.S. patent application Ser. No. 10/942,366, filed on Sep. 16, 2004, now U.S. Pat. No. 7,117,742, which claims the benefit of U.S. Provisional Application No. 60/505,120, filed on Sep. 22, 2003. This application claims the benefit of U.S. Provisional Application No. 60/903,385, entitled “Smart vehicle's fuel storage tank,” filed on Feb. 26, 2007, which is hereby incorporated herein by reference in its entirety.

### BACKGROUND OF THE INVENTION

The present invention relates to storage devices and, more particularly to, gas tanks having systems for monitoring structural conditions thereof.

It is of prime importance in designing a gas tank that the gas tank be capable of withstanding the specified gas pressure. However, the integrity of the gas tank may be degraded due to various types of physical damages, such as mechanical impacts and fatigue accumulated in the tank components due to repeated filling/emptying cycles. Thus, the structural conditions of the gas tank need to be checked on a regular basis.

Currently state-of-art technologies for monitoring the structural conditions of gas tanks are based on ultrasonic and strain monitoring techniques. These approaches have a difficulty in that, as the gas tank needs to be disassembled from the integral system for inspection, a regular checkup of the tank can be a significant task and quite complicated to result in a high maintenance fee. Also, these approaches might be ineffective and unreliable since they fail to consider the actual operational and environmental conditions of the gas tank, where the structural integrity of the tank may be significantly affected by these conditions. As such, there is a need for a gas tank with a monitoring system that allows an operator to check the integrity of the tank whenever needed and provides reliable evaluation of the structural conditions of the tank.

### SUMMARY OF THE DISCLOSURE

According to one embodiment, a tank includes: an inner liner adapted to contain a gas thereinside and to prevent permeation of the gas therethrough; a shell surrounding the inner liner; and a plurality of diagnostic network patches (DNP) attached to the outside surface of the shell. Each DNP is able to operate as a transmitter patch or a sensor patch, where the transmitter patch is able to transmit a diagnostic signal and the sensor patch is able to receive the diagnostic signal. The diagnostic signal received by the DNP is analyzed to monitor the structural conditions of the tank.

### BRIEF DESCRIPTION OF THE DRAWINGS

FIG. 1A shows a schematic perspective view of a gas tank having a monitoring system in accordance with one embodiment of the present invention.

FIG. 1B shows a schematic front view of the tank in FIG. 1A.

FIG. 1C shows a schematic front view of an electrical cable of the type that might be used in the monitoring system of FIG. 1A.

FIG. 1D shows a schematic cross sectional view of the electrical cable in FIG. 1C, taken along the line A-A.

FIG. 1E shows a schematic perspective view of an electrical connection coupler in FIG. 1A.

FIG. 1F shows an arrangement of diagnostic network patch devices included in the monitoring system of FIG. 1A.

FIG. 1G shows another arrangement of diagnostic network patch devices that might be used in the monitoring system of FIG. 1A in accordance with another embodiment of the present invention.

FIG. 2A shows a schematic cross sectional view of the gas tank in FIG. 1A, taken along a plane parallel to the paper.

FIGS. 2B-4B show schematic cross sectional views of gas tanks in accordance with various embodiments of the present invention.

FIG. 5A shows a schematic front view of a gas tank in accordance with another embodiment of the present invention.

FIG. 5B shows a schematic cross sectional view of the gas tank in FIG. 5A, taken along a plane parallel to the paper.

FIG. 6 shows a partial cut-away front view of a pressure control module for controlling the gas pressure of a gas tank in accordance with another embodiment of the present invention.

FIG. 7 shows a functional block diagram of one embodiment of a monitoring system that might be used to monitor the structural conditions of the gas tank of FIG. 6.

FIG. 8A shows a schematic perspective view of a station for filling gas tanks in accordance with another embodiment of the present invention.

FIG. 8B shows a schematic perspective view of a vehicle capable of filling gas tanks in accordance with another embodiment of the present invention.

### DETAILED DESCRIPTION OF THE PREFERRED EMBODIMENTS

Although the following description contains many specifics for the purposes of illustration, those of ordinary skill in the art will appreciate that many variations and alterations to the following detains are within the scope of the invention. Accordingly, the following embodiments of the invention are set forth without any loss of generality to, and without imposing limitation upon, the claimed invention.

Briefly, the present invention provides a gas tank having diagnostic network patch (DNP) devices to monitor the health conditions of the tank. An interrogation system associated with the DNP devices or transducers establishes signal paths between the devices to form a communication network, where acoustic waves or impulses (such as, Lamb waves) travel through the signal paths. The signals transmitted through the paths are received by some of the DNP devices and the received data are analyzed by the interrogation system to determine the structural conditions of the tank.

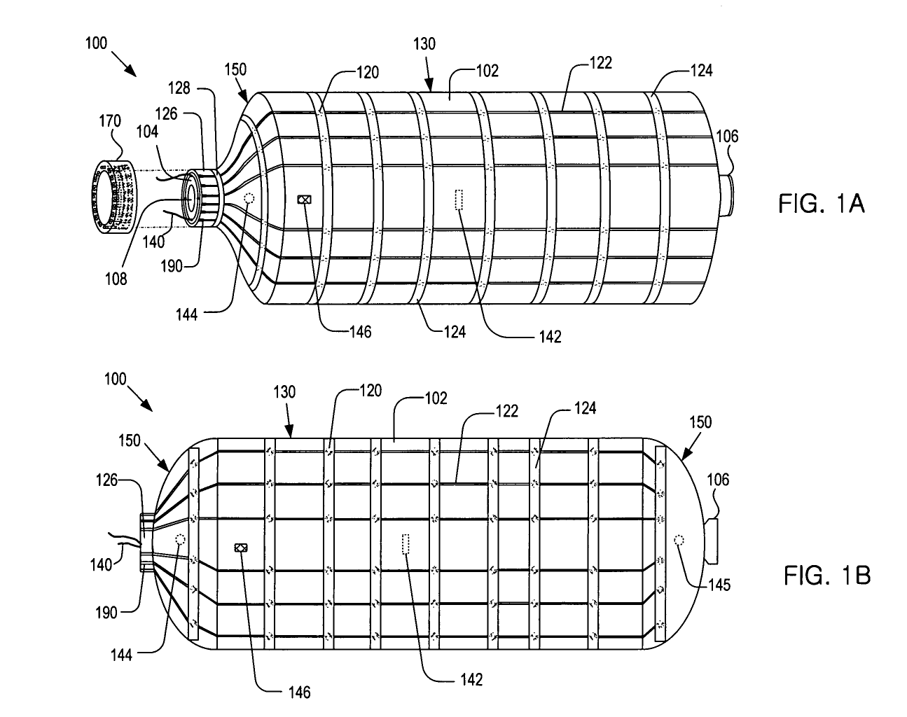

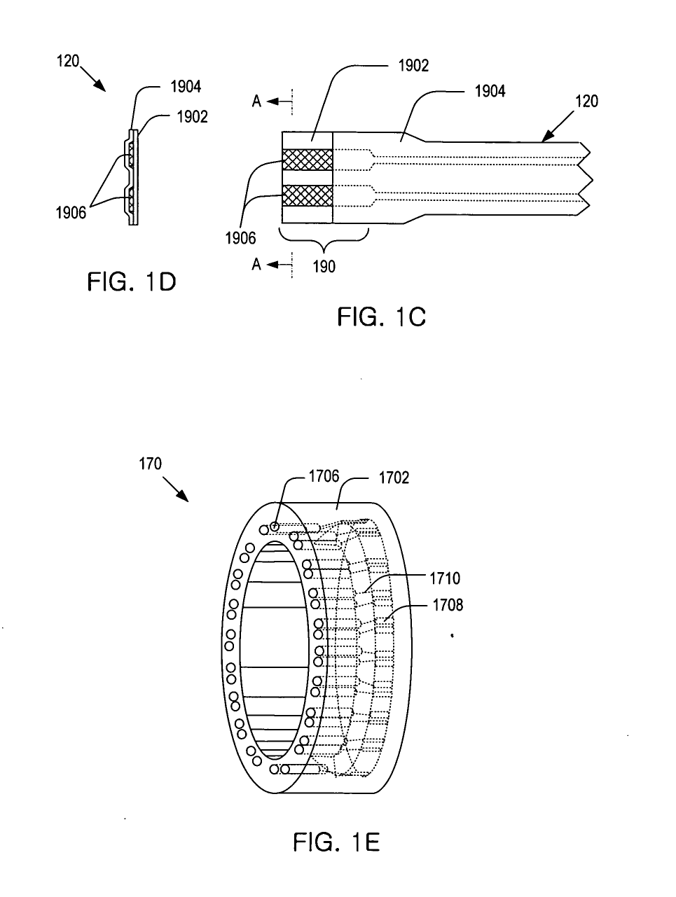

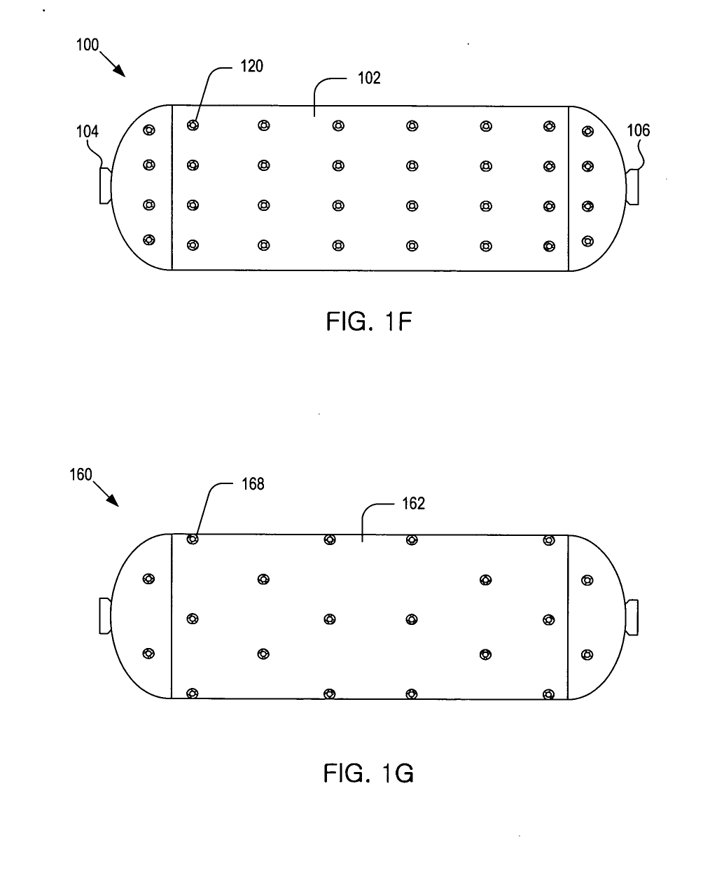

FIG. 1A is a schematic perspective view of a gas tank 100 in accordance with one embodiment of the present invention. For the purpose of illustration, the electrical connection coupler 170, which forms a part of the tank 100, is shown to be separate from the gas tank body. FIG. 1B is a schematic front view of the gas tank 100. As shown in FIGS. 1A-1B, the tank 100 includes: a cylindrical section 130; a pair of end dome sections 150; and one or more bosses 104, 106 disposed at ends of the dome sections 150. The inner side surfaces of the bosses 104, 106 form gas passageways through which the gas is filled in or discharged from the tank 100. It is noted that all the tanks described in the present document may contain a fluid in liquid and/or gas phase. However, for brevity, the tanks are described as gas tanks hereinafter.

An outer shell 102, which forms the outer layer of the tank, is preferably formed of a composite material and fabricated by winding a glass fiber filament impregnated with epoxy or shaping laminated fiber reinforced resin matrix in the form of a hollow shell and baking the hollow shell at a suitable temperature. The shell 102 provides the mechanical strength required to withstand the gas pressure.

A plurality of diagnostic network patch (DNP) devices 120 are attached to the outer surface of the shell 102 and connected to electrical wires 122. The DNP devices 129 are used to interrogate the health conditions of the tank 100 and each DNP device is able to operate as either a transmitter patch or a sensor patch, i.e., each DNP device 120 can be designated as a transmitter patch for transmitting a diagnostic signal, such as Lamb wave or vibrational signal, or as a sensor patch for receiving the signal by an interrogation system (not shown in figures) associated with the DNP devices. The DNP devices 120 and systems for controlling the DNP devices are disclosed in U.S. Pat. Nos. 7,117,742, 7,281,428, 7,246,521, 7,332,244, and 7,325,456 and U.S. patent application Ser. No. 11/880,043, which are incorporated herein by reference in their entirety. The DNP devices 120 may include, for example, a flexible sheet-like sensor having piezoelectric devices covered by a pair of flexible films. In another example, the DNP devices 120 are polyvinylidene fluoride (PVDF) patches.

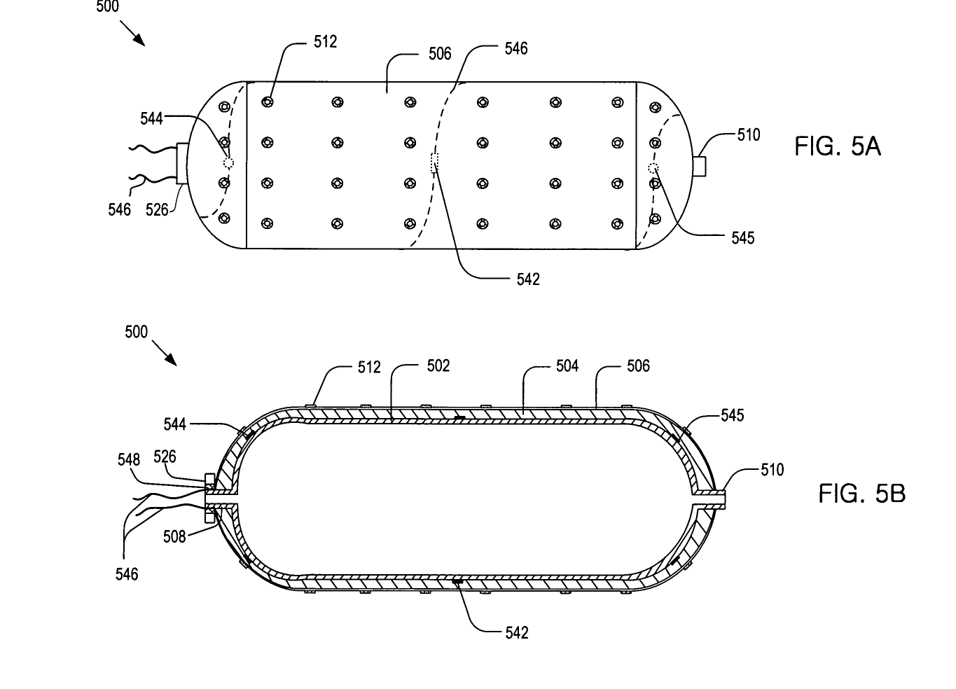

Other types of sensors may be attached to the gas tank 100. For example, optical sensors 144, 145 connected to fiber Bragg gratings 142 via an optical fiber cable 140 can be used to monitor the structural conditions of the gas tank 100. Detailed description of the optical sensors are described in conjunction with FIGS. 5A-5B. In another example, a thermometer 146 may be also provided to measure the temperature of the gas tank, where the measured temperature data can be used in analyzing the diagnostic signals received from the DNP devices 120 and the optical sensors 144, 145.

Covering strips or belts 124 are provided to secure the DNP devices 120 to the outer surface of the shell 102, to protect the DNP devices from physical damage, and to reduce electrical interferences due to the parasite conductance formed by the electrical wires 122. The strips 124 may be formed of a composite material, a homogenous thermoplastic material, or a rubber material, for instance. Each strip 124 may include an embedded electrical conductor, such as metallic foil or wire (not shown in figures), that can be connected to a common electrical ground to reduce the electrical interference.

The electrical wires 122 may include flat flexible electrical cables and attached to the outer surface of the shell 102 by an adhesive, such as cast thermosetting epoxy. The DNP devices 120 are connected to the cables 122, where the end portions of the cables 122 are secured to an electrical connection ring 126 by a strip or belt 128 formed of a composite material. A detailed description of the cables 122 is given below with reference to FIGS. 1C-1D. Also, as discussed below, a ring-shape hoop is interposed between the boss 104 and the electrical connection ring 126, where the hoop holds the fiber optic cables 140 in place between the outer side surface of the boss 104 and the inner side surface of the hoop.

The outer side surface of the electrical connection ring 126 engages into the inner side surface of the electrical connection coupler 170. FIG. 1C shows a schematic front view of an end portion 190 of the electrical cable 122. FIG. 1D shows a schematic cross sectional view of the end portion 190 of the electrical cable 122, taken along the line A-A. As depicted, the cable 122 includes a substrate layer 1902, a cover layer 1904, and conducting wires 1906 covered by the layers 1902 and 1904. The substrate layer 1902 and the cover layer 1904 may be formed of a dielectric material, such as polyimide. The end portion 190 of the cable 122 is wider than the rest of the cable 122. The tip portions of the conducting wires 1906 have a ribbon shape. Also, near the tip of the cable 122, a portion of the cover layer 1904 is removed to expose the conducting wires 1906.

FIG. 1E shows a schematic perspective view of the electrical connection coupler 170 that is preferably formed of a thermoset or thermoplastic material. The electrical connection coupler 170 includes conductor tubes 1706 disposed in a generally ring-shaped body 1702 and rectangular conductors 1708 that are coupled to the conductor tubes 1706 by conductor wires 1710. The rectangular conductor 1708 has a generally ribbon shape and is disposed on the inner side surface of the electrical connection coupler 170. As the electrical connection ring 126 is inserted into the electrical connection coupler 170, the conducting wires 1906 secured to the outer side surface of the electrical connection ring 126 are brought into firm contact with the rectangular conductors 1708. An external device, such as interrogation system (not shown in figures), may communicate electrical signals with the DNP devices 120 via the conductor tubes 1706 and analyze the signals to diagnose the structural conditions of the gas tank 100.

FIGS. 1F-1G show exemplary arrangements of DNP devices 120 and 168 attached to the outer surfaces of the outer shells 102 and 162 in accordance with embodiments of the present invention. For brevity, the other components of the tanks, such as cables and belts, are not shown in FIGS. 1F-1G. It is noted that other suitable arrangements of the DNP devices may be used. A detailed description of how to arrange the DNP devices and how to process the signal data from the DNP devices can be found in U.S. Pat. No. 7,286,964 and U.S. patent application Ser. Nos. 11/827,244,11/827,319, 11/827,350 and 11/827,415, which are incorporated herein by reference in their entirety.

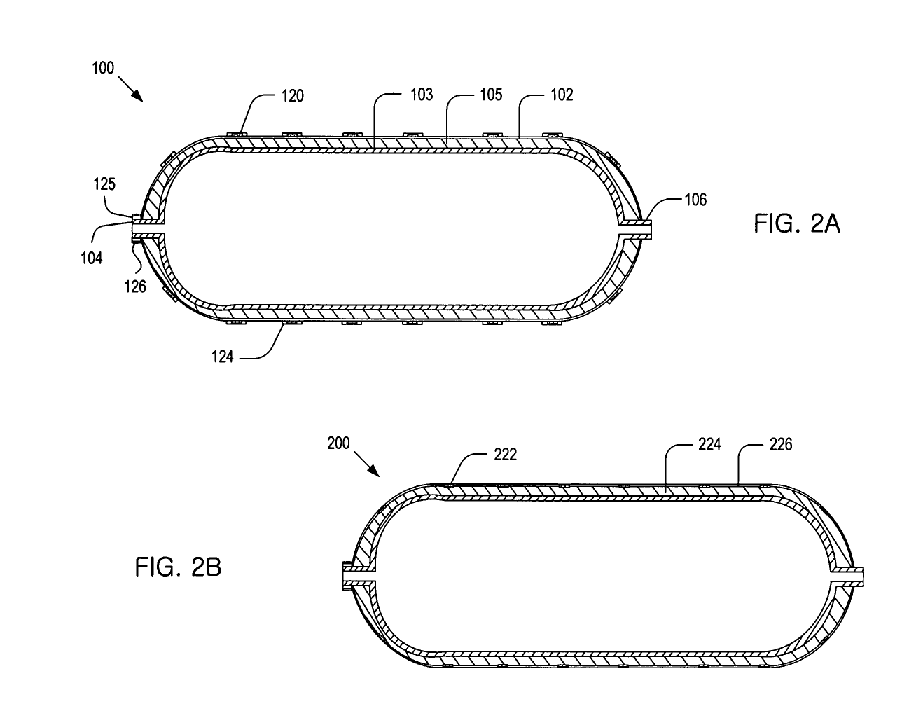

FIG. 2A shows a schematic cross sectional view of the gas tank 100, taken along a plane parallel to the paper. For brevity, the electrical connection coupler 170 and optical sensors 144, 145 are not shown in FIG. 2A. As depicted, the tank 100 includes: a cylindrical inner metallic liner 103 to be in direct contact with a compressed gas inside the liner; an intermediate shell 105 surrounding the inner liner; and an outer shell 102 surrounding the intermediate shell 105. The inner liner 103 is preferably formed of a metal and prevents the compressed gas from permeating the tank wall. The intermediate shell 105 and the outer shell 102 are preferably formed of glass filaments impregnated with epoxy and provide the mechanical strength required to withstand the gas pressure. The outer shell 102 also protects the tank from physical damage. It is noted that the strips 124 cover the DNP devices 120 and secure them to the outer shell 102. As discussed above, a ring-shaped hoop 125 is disposed between the boss 104 and the electrical connection ring 126.

FIG. 2B shows a schematic cross sectional view of a gas tank 200 in accordance with another embodiment of the present invention. As depicted, the tank 200 is similar to the tank 100 in FIG. 2A, with the difference that the DNP devices 222 are disposed between the intermediate shell 224 and the outer shell 226.

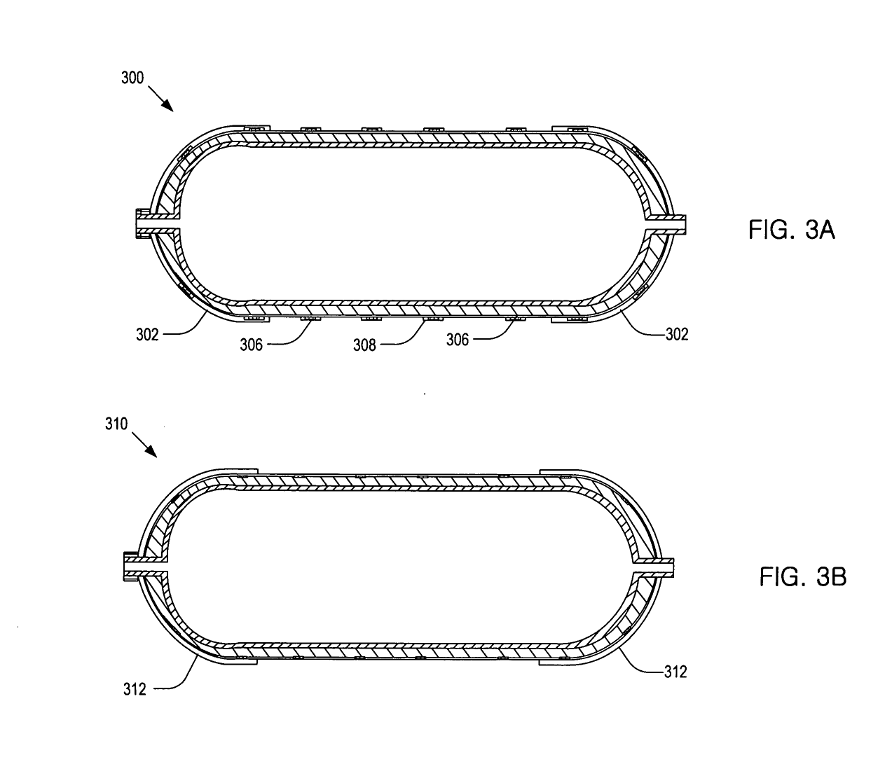

FIG. 3A shows a schematic cross sectional view of a gas tank 300 in accordance with another embodiment of the present invention. The tank 300 is similar to the gas tank 100 in FIG. 2A, with the difference that a pair of impact protection covers 302 covers the dome sections of the tank. The protection covers 302 may also cover some of the DNP devices 306 and the strips 308 and preferably formed of an elastic material, such as rubber.

FIG. 3B shows a schematic cross sectional view of a gas tank 310 in accordance with another embodiment of the present invention. As depicted, the tank 310 is similar to the tank 200 in FIG. 2B, with the difference that a pair of impact protection covers 312 covers the dome sections of the tank.

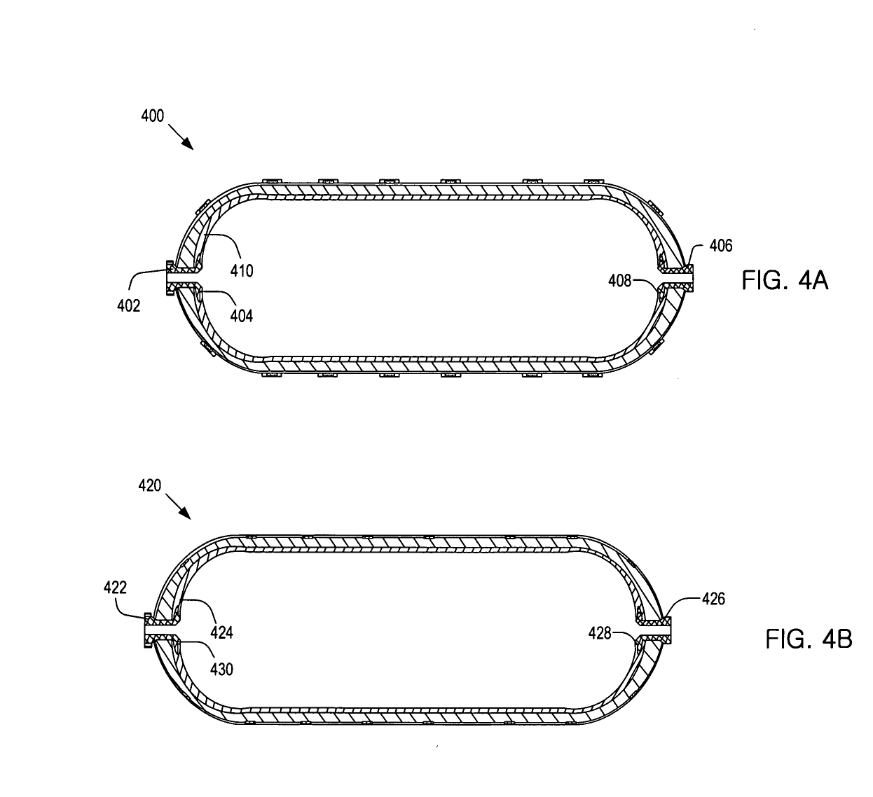

FIG. 4A shows a schematic cross sectional view of a gas tank 400 in accordance with another embodiment of the present invention. As depicted, the tank 400 is similar to the tank 100 in FIG. 2A, with the difference that the bosses 402, 406 have protrusions 404, 408 embedded in the inner liner 410, where the inner liner 410 is preferably formed of a high-weight polymer plastic.

FIG. 4B shows a schematic cross sectional view of a gas tank 420 in accordance with another embodiment of the present invention. As depicted, the tank 420 is similar to the tank 200 in FIG. 2B, with the difference that the bosses 422, 426 have protrusions 430, 428 embedded in the inner liner 420, where the inner liner 420 is preferably formed of a high-weight polymer plastic.

FIGS. 5A-5B respectively show a front view and a cross sectional view of a gas tank 500 in accordance with another embodiment of the present invention. As depicted, the gas tank 500 includes: an inner liner 502; an intermediate shell 504; an outer shell 506; DNP devices 512 attached to the outer shell 506; and bosses 508, 510, where the compositions and functions of these components are similar to their counterparts of the tank 100. The optical sensor system of the tank 500 includes: fiber optic sensors 544, 545; fiber Bragg gratings (FBG) 542; and optical cables 546 connecting the optical sensors to the fiber Bragg gratings.

The optical sensors 544, 545, fiber Bragg gratings (FBG) 542, and the optical cables 546 are disposed between the intermediate shell 504 and the inner liner 502. For instance, the optical cables 546 may be wrapped around the inner liner 502. The both end portions of the optical cables 546 are secured to the outer side surface of the boss 508 by a ring-shaped hoop 548 that is preferably formed of a composite material. More specifically, the ring-shaped hoop 548 is provided at the neck of the boss 508 to secure the end portions of the optical cables 546 to the boss 508. The optical sensor system of the tank 500 is used to measure the strain of the intermediate shell 504 at several locations based on the frequency shift in an acoustic emission (AE) signal received by the sensors 544, 545. Detailed description of the optical sensors can be found in U.S. Pat. No. 7,281,418, which is incorporated herein by reference in its entirety.

It is noted that the DNP devices 512 may be covered by strips, or disposed between the inner liner 502 and the intermediate shell 504, or covered by impact protection covers, as in the cases of FIGS. 2A-4B. It is also noted that an electrical connection ring 526 is disposed around the ring-shaped hoop 548, where the end portions of the electrical cables (not shown in FIGS. 5A-5B) are secured to the outer side surface of the electrical connection ring 526, as in the case of FIG. 1A.

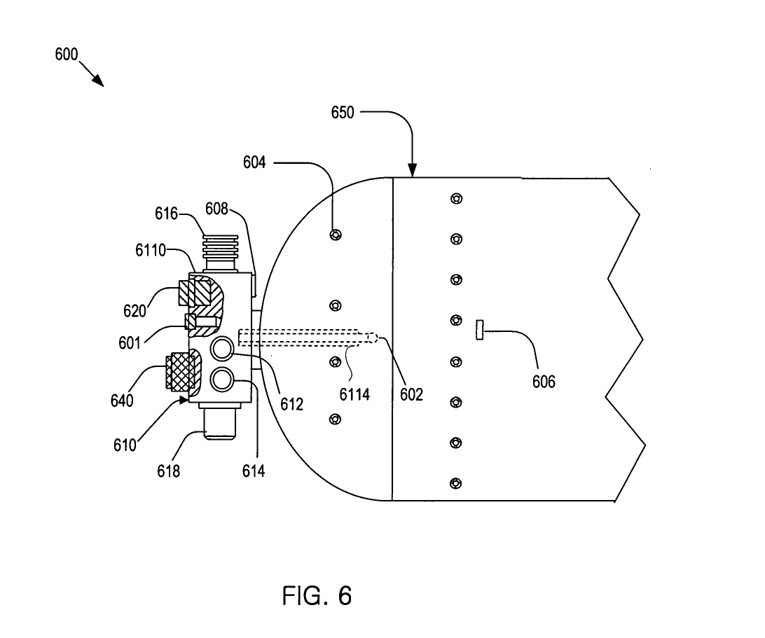

The DNP devices and the optical sensor system depicted in FIGS. 1A-5B are used to monitor the structural conditions of the gas tank. The gas tank may also include another safety monitoring system, referred to as tank usage monitoring system (TUMS), to continuously assess the structural integrity of the tank, to thereby provide a reliable evaluation of the structural health conditions of the tank. FIG. 6 shows a partial cut-away front view of a pressure control module 610 for controlling the gas pressure of the tank 650 in accordance with another embodiment of the present invention. As depicted, the pressure control module 610 attached to the tank 650 includes a TUMS 620.

The pressure control module 610 also includes: a housing 6110; a gas inlet 612; a gas outlet 614; a relief valve 616; a safety valve 618, which is preferably an electrical solenoid valve and controls the gas flow into the tank; and structural health monitor (SHM) controller 640. The SHM controller 640 operates the DNP sensors 604 and optical fiber sensors 606 to monitor the structural health conditions of the tank 650. A pressure transducer 601 may be plugged into a port in the housing 6110 and used to measure the gas pressure in the tank 650.

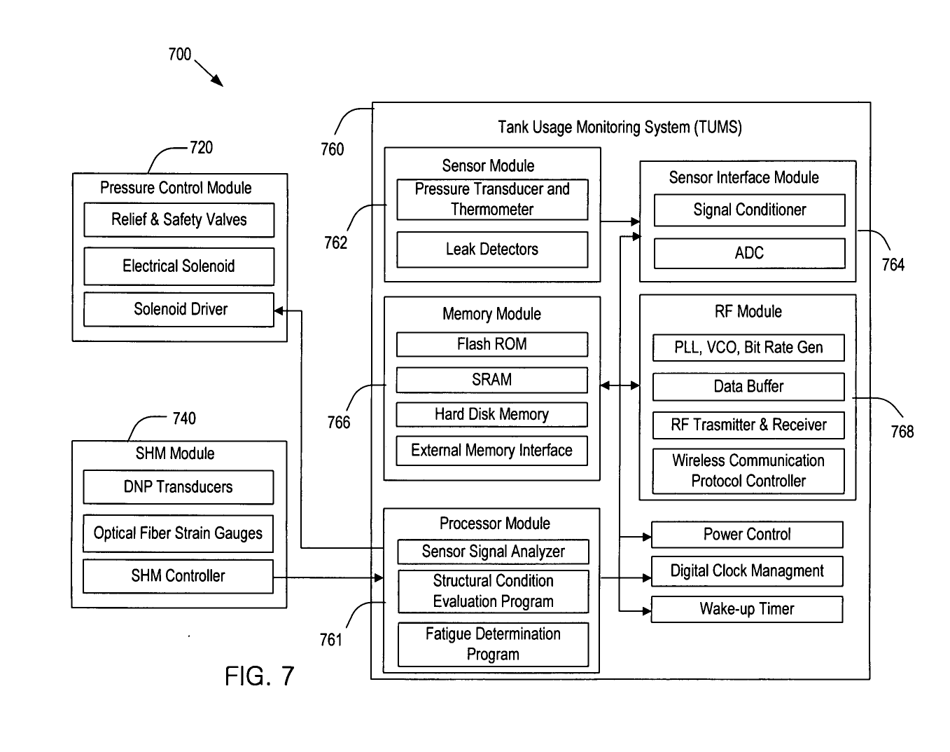

A thermometer 602 is located at the tip of a rod 6114 that extends from the housing 6100 into the space defined by the inner liner of the tank and measures the temperature of the gas in the tank. The signals from the pressure transducer 601 and the thermometer 602 are input to the TUMS 620. As detailed in conjunction with FIG. 7, the TUMS 620 may assess the structural integrity of the tank, using at least one of the signals from the SHM controller 640, the pressure transducer 601, and the thermometer 602, and the information of various structural factors, such as the remaining lifetime of the tank. As a variation, the TUMS 620 may assess the structural integrity of the tank without using those signals and factors. The TUMS 620 can provide the real-time information of the structural integrity and health conditions of the tank and real-time information of the variations in the pressure and temperature of the gas in the tank. The TUMS 620 may also issue warning signals to the human operator or actuate a solenoid driver (not shown in FIG. 6) to close the safety valve 618 upon detection of abnormal structural conditions.

A leak sensor 608 may be attached to the housing 6110 or to the outer shell of the tank 650 and transmit a detection signal to the TUMS 620. The pressure control module 610 may calculate the maximum allowable gas pressure based on the assessed structural integrity and fatigue accumulated in the tank components and regulate the gas flow through the gas inlet 612 so that the gas pressure does not exceed the maximum allowable level. When physical damage or material property degradation of the tank 650 is detected, the TUMS 620 may actuate the solenoid to close the safety valve 618, to thereby stop filling the gas tank 650. When the TUMS 620 determines that the fatigue accumulated in the tank components due to the repeated filling/emptying cycles reaches to a predetermined level, the TUMS 620 also closes the valve 618. Moreover, when the leak detector 608 detects a gas leakage, the gas tank may not be filled again until the leak problem is resolved. To perform incipient leak detection and to provide a warning signal to a human operator, one or more of a micro-electrical mechanical system (MEMS) gas sensor, an optical fiber gas sensor, and a comparative vacuum monitoring (CVM) sensor may be coupled to the pressure control module 610.

FIG. 7 illustrates a functional block diagram of one embodiment of a monitoring system 700 that might be used to monitor the structural conditions of the gas tank 650 of FIG. 6. The monitoring system 700 includes: a Tank Usage Monitoring System (TUMS) 760; a Structural Health Monitor (SHM) module 740; and a pressure control module 720. The TUMS 760 includes: a sensor module 762 for sensing the pressure and temperature of the gas and detecting gas leakage; a sensor interface module 764 for conditioning the sensor signals received from the sensor module and converting the sensor signals to digital signals; a memory module 766 for storing the digital signals and program codes; an RF module 768 for performing wireless communications with a remote device; and a processor module 761 for controlling the modules included in the TUMS 760. A SHM controller of the SHM module 740 controls the DNP devices 604 and optical fiber sensors 606. The SHM controller receives sensor signals from the DNP devices 604 and optical fiber sensors 606, and processes the received signals. The SHM module 740 may provide the information of structural conditions, such as physical damage, material property degradation, structural strength, and strain of the tank wall, to the processor module 761. The SHM module 740 is disclosed in U.S. Pat. Nos. 7,281,428, 7,246,521, 7,322,244 and a U.S. patent application Ser. No. 11/861,781, which are incorporated herein by reference in their entirety. As disclosed above, the pressure control module 720 may include a relief valve and/or a check valve, a safety valve, and a driver to control the valves.

The TUMS 760 may further include circuits or devices for power control and digital clock management, and a wake-up timer for issuing signals so that the processor can enter or exit a sleep (or energy saving) mode.

The sensor module 762 of the TUMS 760 may include a pressure transducer, thermometer, and leak detectors. The sensor interface module 764 may include signal conditioning circuits and analog-to-digital converters (ADC). The memory module 766 may include a flash ROM, a SRAM, a hard disk memory, a flash memory, and a solid-state disk memory, such as USB compact flash memory, and an external memory interface. The memory module 766 stores the data generated by the ADC and the program codes. Also, the data related to the process of filling the tank, such as gas pressure and temperature profiles, and the information of the structural conditions of the tank, may be stored into the memory module 766 to thereby keep usage history data. A human operator can retrieve the usage history data to assess the structural integrity and remaining lifetime and to perform a reliability evaluation and/or maintenance of the tank. The radio frequency (RF) module 768 may comprise: an RF signal generation circuit including phase lock loops, voltage-controlled oscillators, and bit rate generators; data buffers; an RF transmitter and a receiver; and a wireless communication protocol controller. The wireless communication protocol controller controls the devices in the RF module 768, provides wireless communication protocols, and transmits the usage history data of the tank to a remote device.

The processor module 761 of the TUMS 760, which controls the sensor module 762, sensor interface module 764, memory module 766, and RF module 768, may monitor the pressure and temperature of the gas in the tank, to thereby maintain the gas pressure below a predetermined level. The processor module 761 may issue and transmit a shutdown signal to the pressure control module 720 so that the pressure control module 720 can stop filling the tank. Moreover, the processor module 761 may receive a signal from a leak detector, issue a warning signal, and stop filling the tank.

A processor of the processor module 761 may perform a fatigue analysis using the usage history data stored in memory module 766, analyze the structural condition data, such as strain, physical damage, material property degradation of the tank, and provide the information of the available filling/emptying cycles to the user, where the structural condition data is provided by the SHM controller of the SHM module 740. Also the processor of the processor module 761 may keep track of records related to filling/emptying cycles, analyze the temporal profiles of the pressure and temperature during the filling/emptying cycles, provide the information of the available filling/emptying cycles, and stop filling the tank when the lifetime of the tank is reached.

Certain tanks may contain a material, such as metal hydride, on which the gas is adsorbed. In such a case, the pressure of the gas in the tank does not increase monotonically during the gas filling process. In analyzing the temporal profiles of gas pressure and temperature to determine whether a plateau in the pressure profile corresponds to the intended target pressure of the filling cycle, the processor of the processor module 761 may use a level crossing algorithm or a probability-based algorithm.

The lifetime of the tank may be calculated from the material properties of the tank walls, with an assumption that a constant pressure load is applied to the tank. Also, the lifetime of the tank may be determined using the results from various laboratory fatigue tests. As the fatigue accumulated in the tank components is dependent on the operational and environmental conditions, the lifetime of the tank is recalculated after a preset number of filling/emptying cycles so that the current structural strength and the previous usage history of the tank are considered in determining the lifetime.

In estimating the remaining lifetime of the tank, the processor module 761 may apply a fatigue damage rule to the analysis of the current structural conditions, where the information of the current structural conditions, such as local structural strength degradation due to delamination or physical impacts, global material property degradation due to environmental loads of thermal heat, humidity, radiation and ionization, and strain rate change in the tank, is provided by the SHM controller 740. The fatigue damage rule may include a Miner's rule, a probability-based cumulative damage rule, or a rule upon which a progressive fatigue damage algorithm is based.

The TUMS 760 may be stored in a system-on-chip (SoC) using a CMOS technology. The SoC may include a pressure transducer and a thermometer. The TUMS processor 761 may include a Field Programmable Gate Array (FPGA) or a complex programmable logic device (CPLD) for operating analog-to-digital converters, memory devices, and sensor interfaces for the pressure transducer and thermometer. As discussed above, the TUMS 760 may include an RF transmitter and an RF receiver for communicating information of the structural health conditions and remaining lifetime of the tank with a remote device so that the remote device user can monitor the structural and operational conditions of the tank and receive a warning signal if the tank needs immediate attention.

The structural integrity may be degraded by various types of physical damages, such as mechanical impacts and fatigue due to the repetition of filling/emptying cycles. If the integrity level decreases below a preset lower limit, a human operator or remote user may send a signal to the TUMS 760 via a wireless communication channel, causing the TUMS to shut off the inlet valve of the tank. Also, if the gas pressure in the tank exceeds the maximum allowable limit, the human operator or remote user can also shut off the inlet valve of the tank. By way of example, the TUMS 760 may utilize Bluetooth or Zigbee communication protocols. The TUMS 760 may be coupled to the Internet so that a web-enabled device may remotely receive the data stored in the TUMS memory devices.

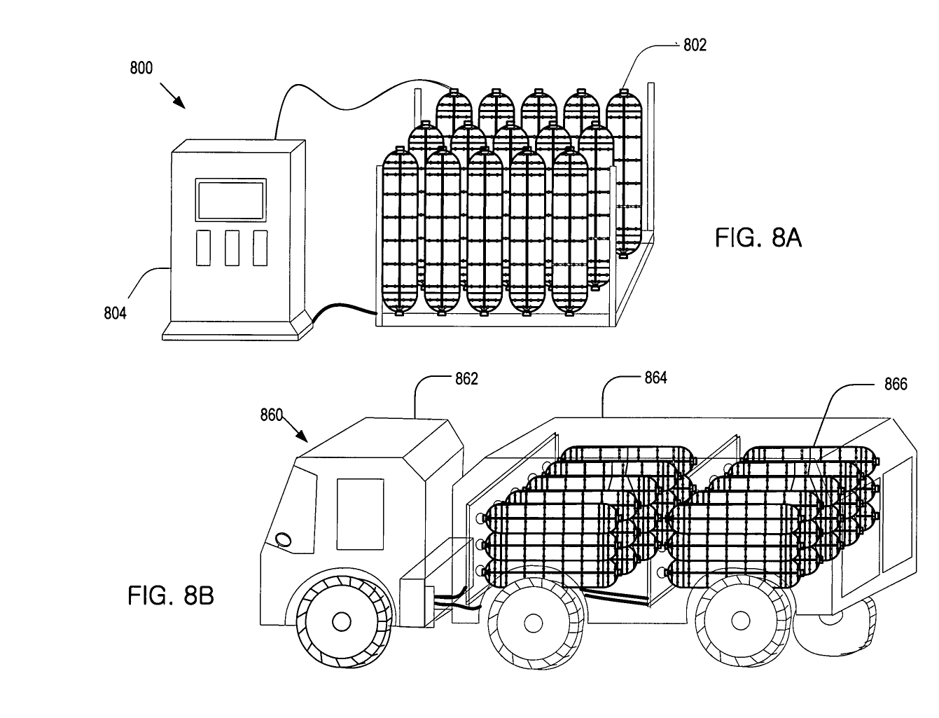

FIG. 8A shows a schematic perspective view of a station 800 for filling gas tanks in accordance with another embodiment of the present invention. As depicted, a pump 804 may be used to fill the gas tanks 802. FIG. 8B shows a schematic perspective view of a vehicle 860 capable of filling gas tanks in accordance with another embodiment of the present invention. The vehicle 860 may include a cargo bay 864 to accommodate the gas tanks 866 and fill the tanks, i.e., the vehicle operates as a mobile gas filling system. While the tanks 802 and 866 are filled, the TUMS associated with each tank may communicate with the pump 804 or the vehicle 860. More specifically, the TUMS prepares the current status data of the tank, such as tank volume, measures gas pressure and temperature, and retrieves the structural condition data from a SHM controller. The TUMS then transfers the data to the station 800 or vehicle 860 so that the tank is filled with an optimum amount of gas. The TUMS, station, and vehicle may have suitable data exchange mechanisms, such as Infrared Data Association (IrDA) transmitter/receiver.

The disclosed tanks and monitoring systems may be used for various types of gases and/or liquids, such as hydrogen. The tanks and monitoring systems may include carbon nanotubes (CNT) and carbon nanofibers (CNF) hydrogen storage systems. The TUMS may be applied to valve systems, pipelines, and conduits of the gas.

While the present invention has been described with reference to the specific embodiments thereof, it should be understood that the foregoing relates to preferred embodiments of the invention and that modifications may be made without departing from the spirit and scope of the invention as set forth in the following claims.

What is claimed is:

1. A tank, comprising:
an inner liner adapted to contain a gas thereinside and to prevent permeation of the gas therethrough;
a shell surrounding the inner liner; and
a plurality of diagnostic network patches (DNP) attached to an outer surface of the shell;
wherein each of the patches is able to operate as at least one of a transmitter patch and a sensor patch, the transmitter patch is able to transmit a diagnostic signal, and the sensor patch is able to receive the diagnostic signal.

2. The tank of claim 1, further comprising:
a plurality of electrical cables connecting the diagnostic network patches to an external device.

3. The tank of claim 2, further comprising:
an electrical connection ring to which end portions of the electrical cables are secured.

4. The tank of claim 3, further comprising:
an electrical connection coupler having a generally hollow tubular shape and an inner side surface in contact with an outer side surface of the electrical connection ring, the electrical connection coupler including a plurality of connectors for connecting the end portions of the electrical cables to the external device.

5. The tank of claim 2, wherein each said electrical cable includes a substrate layer, conducting wires, and a cover layer.

6. The tank of claim 1, further comprising:
a plurality of fiber optic sensors disposed between the inner liner and the shell and operative to measure a strain of the shell.

7. The tank of claim 1, further comprising;
a thermometer attached to the shell and operative to measure a temperature of the tank.

8. The tank of claim 1, further comprising:
a plurality of strips for securing the DNP to the shell and protecting the DNP.

9. The tank of claim 1, wherein the diagnostic signal includes at least one of a Lamb wave and a vibration signal.

10. The tank of claim 1, further comprising:
a structural health monitor controller for operating the DNP and processing the diagnostic signal received by the sensor patch.

11. The tank of claim 1, further comprising:
a pressure control module attached to the tank and including:
at least one safety valve;
at least one electrical solenoid to operate the safety valve; and
a solenoid driver to actuate the solenoid.

12. The tank of claim 1, wherein the shell is formed of a composite material.

13. The tank of claim 1, wherein the inner liner is formed of a material selected from the group consisting of metal and polymer plastic material

14. The tank of claim 8, wherein the strips are formed of a material selected from the group consisting of composite material, homogenous thermoplastic material, and rubber material.

15. The tank of claim 1, further comprising:
an additional shell interposed between the shell and the inner liner.

16. The tank of claim 15, wherein the additional shell is formed of a composite material.

17. The tank of claim 1, further comprising:
an additional shell surrounding the shell.

18. The tank of claim 17, wherein the additional shell is formed of a composite material.

19. The tank of claim 17, further comprising:
an impact protection cover surrounding a portion of an outer surface of the additional shell.

20. The tank of claim 19, wherein the impact protection cover is formed of an elastic material.
